(19) United States
(12) Patent Application Publication
(10) Pub. No.: US 2003/0063345 A1
(43) Pub. Date: Apr. 3, 2003

(54) Wayside user communications over optical supervisory channel

(76) Inventors: Dan Fossum, Ottawa (CA); Carl Krentz, Manotick (CA); Ross Saunders, Ottawa (CA); Michael J. Simpson, Ottawa (CA)

Correspondence Address: HARNESS, DICKEY & PIERCE, P.L.C., P.O. BOX 828, BLOOMFIELD HILLS, MI, 48303, US

(21) Appl. No.: 09/968,951

(22) Filed: Oct. 1, 2001

(51) Int. Cl. H04B 10/08; H04B 10/20; H04J 14/00

(52) U.S. Cl. 359/118; 359/110

(57) ABSTRACT

A wayside Ethernet communications system is presented for use with an optical network. The wayside Ethernet communication system includes a first and second optical network element connected to the optical network. The first optical network element having is adapted to map the Ethernet frames into at least one optical network frame and operable to transmit the optical network frames over an optical supervisory channel of the optical network. The second optical network element is adapted to receive the optical network frames over the optical supervisory channel of the optical network and to extract the Ethernet frames from the optical network frames.

### FIELD OF THE INVENTION

The present invention relates generally to optical network systems and in particular to wayside communications systems for use with an optical network.

### BACKGROUND OF THE INVENTION

Optical network systems such as the synchronized optical network/synchronous digital hierarchy network (SONET/SDH) and dense wave division multiplexing network are deployed by a carrier over a large geographical area. Current technology supports transparent amplification and/or multiplexing at each network element with an optical supervisory channel out of the payload bandwidth that provides access to operations, administration, maintenance, and provisioning of the network and facilitation of semi-autonomous process such as distributed control loops necessary for the proper operation of the system. The operations communications infrastructure implemented through the optical supervisory channel provides data communication services strictly to manage the optical network itself. Transit communications or communications paths that both originate and terminate outside the optical network and use only the optical network for connectivity are not generally supported by optical network systems.

Carriers commonly need to build entirely disjoint overlay data networks to provide data communication services for their own applications. Even where entirely disjoint overlay data networks are implemented, however, data services are generally only provided at larger sites so that small sites such as remote amplifiers are left without services. Disadvantages associated with implementing separate overlay data networks include the purchase of dedicated data networking equipment such as routers and bridges along with the acquisition of wide area network connectivity solutions, such as dial up lines, T1/T3, or OC3 connections. In many instances, additional fibers have been exclusively allocated for intersite carrier communication at high cost. Due to the disadvantages associated with implementing entirely separate overlay data networks, some SONET/SDH systems have implemented a provisioned load bit rate channel between two specific network elements by mapping 10BT Ethernet packets into unused bytes in the SONET/SDH overhead. Limitations associated with this solution include low bit rate (less than 10 Mb/S), a restriction to be point to point connected, the need for manual provisioning, a restriction on the scope of the connection, and a requirement for additional dedicated hardware.

The problems associated with communication between optical switches across an optical transport network has attracted the attention of the optical networking forum, which has defined an O-UNI Ethernet out of band signaling channel. This channel relies on additional networking equipment to implement the Ethernet channel connecting multiple optical UNI devices. Another proposal by the optical networking forum is to use a dedicated wavelength to implement a signaling channel between O-UNI devices. This dedicated wavelength does not rely on additional equipment to implement the signaling channel. However, it consumes an entire wavelength for this function and also demands a more costly interface type (OC3 PoS vs. 10BT Ethernet) on the UNI device.

None of the attempted solutions to the aforementioned problems associated with providing wayside Ethernet have sufficiently addressed those problems. Therefore, it remains the task of the present invention to provide a wayside data communications system that utilizes only existing equipment in an optical network, possesses a high bit rate, and is not restricted to point to point connection.

### SUMMARY OF THE INVENTION

A wayside Ethernet communications system is presented for use with an optical network. The wayside Ethernet communication system includes a first and second optical network element connected to the optical network. The first optical network element having is adapted to map the Ethernet frames into at least one optical network frame and operable to transmit the optical network frames over an optical supervisory channel of the optical network. The second optical network element is adapted to receive the optical network frames over the optical supervisory channel of the optical network and to extract the Ethernet frames from the optical network frames.

For a more complete understanding of the invention, its objects and advantages, reference may be had to the following specification and to the accompanying drawings.

### BRIEF DESCRIPTION OF THE DRAWINGS

FIG. 1 is a diagram of a conceptual model of a wayside communication system in accordance with the present invention.

FIG. 2 is a flowchart depicting network processing in accordance with the present invention.

### DETAILED DESCRIPTION OF THE PREFERRED EMBODIMENTS

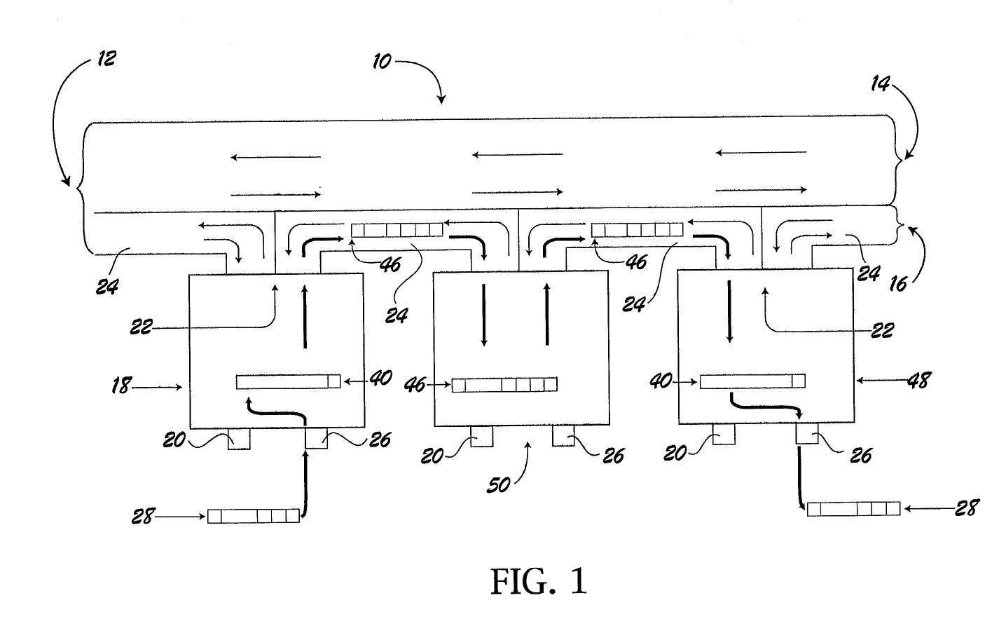

Referring to FIG. 1, a wayside communication system 10 in accordance with the present invention is shown, wherein an ANSI/IEEE Std. 802.3 compliant wayside Ethernet is preferably implemented. A total optical bandwidth 12 is partitioned into an optical payload bandwidth 14 and an optical supervisory channel bandwidth 16. The bandwidth is depicted as full duplex, but the wayside communication system 10, in accordance with the present invention, may be implemented so as to transmit in only one direction.

An exemplary first optical network element 18 is connected to the optical network. The first optical network element 18, such as an amplifier or optical add drop multiplexer, employs a network processing means. A network processing means may be a network processor such as those manufactured by MMC or the popular Intel IXP 1200. A network processing means may be a general purpose embedded microprocessor and could also be implemented through software. A network processor, however, remains the best candidate for a processing means due to its superior performance characteristics over software, customizability and ease of interfacing with an optical network system.

The first optical network element 18 possesses a service Ethernet port 20 in order to permit service technicians to interface with a remote optical network element through disjoint overlay data networks, dedicated wavelength, or similar means previously known. Inherent to a first optical network element 18 is a channel interface 22 for converting signals in the optical domain to signals in the electrical domain and vice versa.

As shown, the first optical network element 18 receives optical network frames from the optical supervisory channel 24 via the channel interface for provisioning, managing and generally operating the optical transmission system itself. In a preferred embodiment, almost all applications running over the optical supervisory channel 24 are packetized and bear an identifying label constituting an internal class of service tag. Thus, network processing may distinguish, for example, between administrative packets, network control packets and wayside packets based on the different labels.

The first optical network element 18 differs from a typical optical network element in two ways. First, first optical network element 18 has a wayside Ethernet port 26. Second, first optical network element 18 has been adapted to map Ethernet frames as packets into optical network frames, such as SONET or SDH frames, for transmission over the optical supervisory channel 24 of the optical network. In a preferred embodiment, Ethernet frames are mapped into the payload portion of the optical network frames.

In accordance with the present invention, the Ethernet frame 28 is communicated to the first optical network element 18 via the wayside Ethernet port 26. First optical network element 18 maps Ethernet frame 28 into the payload portion of an optical network frame 40 having overhead bytes 42 and payload bytes 44. As will be readily appreciated by one skilled in the art, a typical Ethernet frame 28 is greater in length than a typical optical network frame 40, so that the Ethernet frame 28 will likely need to be mapped into the payload portion of several optical network frames. This type of mapping may be accomplished with such protocols as Packet Over Sonet and Point To Point Protocol. For illustration purposes, an Ethernet frame 28 is mapped to a single optical network frame, thereby creating an Ethernet packet 46 which bears an identifying label distinguishing it from other types of traffic on the optical supervisory channel. In a preferred embodiment, the label is a four byte integer encoded in the Point to Point Protocol ID field.

First optical network element 18 determines from the destination address field 38 that the Ethernet packet 46 is destined for a second optical network element 48. The Ethernet packet 46 is converted from the electrical domain to the optical domain via the channel interface 22 and communicated to the optical supervisory channel 24 for transmission over the optical supervisory channel 24 as shown. The Ethernet packet 46 is received at the second optical network element 48. Second network element 48 possesses the characteristics inherent to a typical optical network element such as a channel interface 22, and a service Ethernet port 20.

Similarly to first optical network element 18, second optical network element 48 also differs from a typical optical network element in two ways. First, second optical network element 48 possesses a wayside Ethernet port 26. Second, the second optical network element 48 is adapted to receive Ethernet frames transmitted over the optical supervisory channel 24. Second optical network element 48 recognizes wayside Ethernet packets based on an identifying label distinguishing them from other types of optical supervisory channel traffic, and retrieves Ethernet frames mapped as packets into a payload portion of optical network frames. The Ethernet packet 46 is received by the second optical network element 48 via the channel interface 22 that converts Ethernet packet 46 from the optical domain to the electrical domain. Second optical network element 48 determines from the internal class of service tag that the Ethernet packet 46 is of type wayside Ethernet. Second optical network element 48 also determines from the destination address field 38 that the Ethernet packet 46 is destined for the second optical network element 48. Second optical network element 48 retrieves the Ethernet frame 28 from the optical network frame 40 using Packet Over Sonet and Point To Point Protocol to remove the identifying label. Second optical network element 48 then outputs the Ethernet frame 28 through the wayside Ethernet port 26.

Situated between first optical network element 18 and second optical network element 48 may be a third optical network element 50. Third optical network element 50 possesses the characteristics inherent to a typical optical network element such as a channel interface 22, a service Ethernet port 20, and a network processing means. Third optical network element 50 differs from a typical optical network element in two ways. First, third optical network element 50 possesses a wayside Ethernet port 26. Second, third optical network element 50 is adapted to forward Ethernet packets received over the optical supervisory channel 24 from the first optical network element 18 to the second optical network element 48. The Ethernet packet 46 is communicated to the third optical network element 50 via the channel interface 22. The third optical network element 50 determines from an internal class of service tag associated with the Ethernet packet 46 that the Ethernet packet 46 is of type wayside Ethernet. Third optical network element 50 then determines from the destination address field 38 that the Ethernet packet is destined for the second optical network element 48. The third optical network element 50 communicates the Ethernet frame 46 to the optical supervisory channel 24 via the channel interface 22 for transmission to the second optical network element 48.

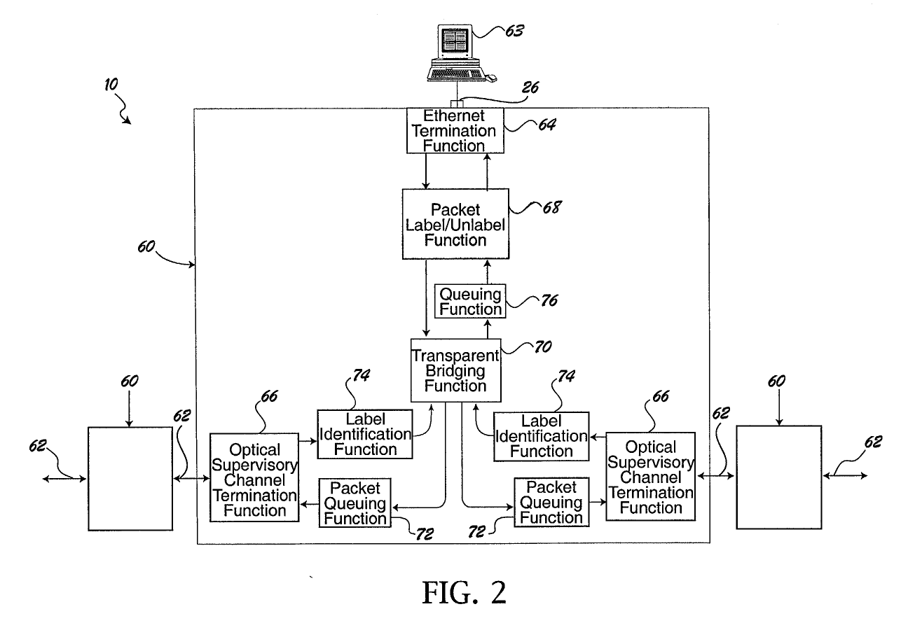

Referring to FIG. 2, a flow chart diagram of network processing for a wayside communication system 10 is shown. In the wayside communication system 10, each optical network element 60 communicates with at least one other optical network element 60 via optical supervisory channel communication 62. The optical supervisory channel communication 62 is displayed as being bi-directional. However, optical supervisory channel communication 62 may, also be uni-directional. A wayside Ethernet source/receptacle 63 is in communication with an optical network element 60 and interfaces via a wayside Ethernet port 26 with an Ethernet termination function 64. Similarly, optical supervisory channel communication 62 interfaces with optical supervisory channel termination function 66.

Network processing consistent with the present invention may be subdivided into three categories of processing. These categories are transmit processing, receive processing, and forward processing. Transmit processing is the processing required to send an Ethernet frame 28 (FIG. 1) as an Ethernet packet 46 (FIG. 1) to a peer network element 60 by means of optical supervisory channel communication 62, transmit processing begins when an Ethernet frame 28 (FIG. 1) is communicated from Ethernet source/receptacle 63 to the Ethernet termination function 64 via wayside Ethernet port 26.

In accordance with the transmit processing, the Ethernet termination 64 receives the Ethernet frame 28 and communicates it to a packet label/unable function 68, the packet label/unlabel function 68 labels the frame as being wayside Ethernet and assigns an internal class of service tag, herein referred to as a label. Labels can be assigned in a number of different manners including prepending a custom tag to the incident frame or packet, inserting a standard shimmed multi protocol layer switching header, overriding the Internet protocol checksum field in an Internet protocol packet, and defining custom point to point protocol types. In a preferred embodiment, a four byte integer value is used as a tag and the Point To Point Protocol ID field is used to encode the labeling.

The resulting Ethernet packet is then communicated to a transparent bridging function 70. Preferably ANSI/IEEE 802.1D Std. compliant, the transparent bridging function 70 is “transparent” in the sense that, as far as the end user is concerned, they are connected to the same Ethernet Line Access Network Segment and are unaware of any Ethernet bridges in between. The transparent bridging function 70 records the Ethernet source address and originating port in the local filtering table. Additionally, the transparent bridging function 70 looks up the Ethernet destination address in the local filtering table and determines the outgoing port. In accordance with transmit processing, the outgoing port corresponds to one of the optical supervisory channel terminations 66. The transparent bridging function then forwards the packet to the outgoing port. As a result, the Ethernet packet is communicated to the packet queuing function 72 associated with the appropriate optical supervisory channel termination 66. At the packet queuing function 72, the packet is enqueued according to rules associated with the internal class of service tag, wherein higher priority traffic is transmitted first. The packet is then transmitted over the optical supervisory channel 24 (FIG. 1) to an appropriate peer optical network element 60 by means of the optical supervisory channel termination 66.

Receive processing is initiated when an Ethernet packet 46 is received by an optical supervisory channel termination 66. The packet is communicated to a label identification function 74 where the packet is recognized as being Wayside Ethernet and the transparent bridging function 70 is invoked to process the packet. The transparent bridging function records the Ethernet source address and originating port in the local filtering table and looks up the Ethernet destination address in the local filtering table where it determines that the outgoing port is the local wayside Ethernet port 26. The transparent bridging function 70 then forwards the packet to the local wayside Ethernet port 26 by communicating the packet to the queuing function 76. The queuing function 76 enqueues the packet according to rules associated with the internal class of service tag, wherein higher priority traffic is transmitted first. The queuing function 76 communicates the packet to the packet label/unlabel function 68 where the Wayside label is removed from the packet. The resulting original Ethernet frame 28 (FIG. 1) is transmitted out the wayside Ethernet port 26 via the Ethernet termination 64 to wayside Ethernet source/receptacle 63.

Forward processing is initiated when a packet is received by the optical supervisory channel termination 66. The packet is communicated to the label identification function 74 where it is recognized as being Wayside Ethernet and the Wayside transparent bridging function 70 is invoked to process it. The transparent bridging function 70 records the Ethernet source address and the originating port in the local filtering table looks up the Ethernet destination address in the local filtering table and determines that the outgoing port is associated with a second optical supervisory channel termination 66. The transparent bridging function 70 then forwards the packet to the outgoing port by communicating it to the packet queuing function 72 associated with the outgoing port. At the packet queuing function 72, the packet is enqueued according to rules associated with the internal class of service tag, wherein higher priority traffic is transmitted first. The packet is then transmitted over the optical supervisory channel 24 (FIG. 1) to the peer network element 60 via the optical supervisory channel termination 66 associated with the outgoing port.

In a preferred embodiment, each optical network element 60 in a wayside communications system 10 is capable of all three forms of network processing as displayed in FIG. 2. The resulting wayside communication system 10 thus provides connectivity to all sites where equipment belonging to the optical network is deployed, and is capable of being scaled to provide network wide scope from a single access point.

Of note, it is generally necessary for the transparent bridging function 70 to determine an outgoing port during processing, but there may be more than one outgoing port. In one embodiment of the present invention, if the destination address is a broadcast address, then the packet is forwarded out all ports except the one that it originated on. Also, if the destination address is not in the forwarding table, then the packet is “flooded” and sent out all ports except the incident port.

It is also possible to implement a second wayside communication that is point to point between network element wherein these types of Ethernet packets are labeled as a second type of wayside Ethernet communication. The network processing for these types of packets is simpler in that the label identification function 74 recognizes the packet as being of the second type of wayside Ethernet communication when the packets are received. As a result of that recognition, there is no need for the transparent bridging function 70 to look up or record any addresses in the local filtering table. Instead, the packet may be communicated to the queuing function 76 and processed in accordance with the receive processing. Thus, as a result of the second type of wayside Ethernet communication, Ethernet packets are sent directly between optical network elements and dropped automatically without a possibility of being forwarded. Both types of wayside Ethernet communication may be implemented within the same wayside communication system 10, resulting in the ability to send Ethernet packets in both ways. Notably, it is also possible to implement multiple, concurrent implementations of wayside Ethernet of the first type by assigning unique labels to each and implementing separate filtering functions.

What is claimed is:

1. A wayside communication system for use with an optical network, the system comprising:
a first optical network element connected to the optical network having an interface for receiving Ethernet frames, said first optical network element adapted to map the Ethernet frames into at least one optical network frame and to transmit the optical network frames over an optical supervisory channel of an optical network; and
a second optical network element connected to the optical network, said second optical network element adapted to receive the optical network frames over the optical supervisory channel of the optical network and to extract the Ethernet frames from the optical network frames.

2. The wayside communication system of claim 1 further comprising a third optical network element connected to the optical network, said third optical network element adapted to forward optical network frames received over the optical supervisory channel from said first optical network element to said second optical network element via the optical supervisory channel of the optical network.

3. The wayside communication system of claim 1 wherein Ethernet frames are mapped into a payload portion of at least one optical network frame.

4. The wayside communication system of claim 1 wherein at least one of the first, second and third optical network element comprises:
a processor for processing signals in the electrical domain;
a supervisory channel interface in communication with said processor and operable to at least one of receive signals transmitted over the optical supervisory channel and transmit signals over the optical supervisory channel; and
an Ethernet interface in communication with said processor for at least one of receiving Ethernet frames and transmitting Ethernet frames, wherein said processor bridges in a bridging manner said supervisory channel interface and said Ethernet interface.

5. The wayside communication system of claim 4 wherein the bridging manner is transparent.

6. The wayside communication system of claim 4 wherein said processor is further defined as a network processor.

7. The wayside communication system of claim 4 wherein said network processing means is a general purpose embedded microprocessor.

8. The wayside communication system of claim 4 wherein at least one of said first, second, and third optical network element is further defined as at least one of an optical amplifier and an optical add drop multiplexer.

9. The wayside communication system of claim 4 wherein the first optical network element is operable to label the at least one optical network frame, thereby distinguishing the at least one optical network frame from other types of traffic transmitted over the optical supervisory channel.

10. The wayside communication system of claim 9 wherein the first optical network element is further operable to label the at least one optical network frame by at least one of prepending a custom tag to the at least one optical network frame, inserting a standard shimmed multi protocol layer switching header in the at least one optical network frame, overwriting an Ethernet protocol checksum field embodied in the at least one optical network frame, and defining custom point to point protocol types.

11. The wayside communication system of claim 10 wherein the first optical network element is further operable to label the at least one optical network frame by encoding an identification of a custom point to point protocol.

12. The wayside communication system of claim 1 wherein the optical network frames include at least one of synchronized optical network frames and synchronized digital hierarchy frames.

13. The wayside communication system of claim 1 wherein said first optical network element transmits Ethernet frames utilizing a transmit method, the transmit method comprising:
receiving an Ethernet frame having an Ethernet source address embodied therein;
recording the Ethernet source address and an originating port identifier for the Ethernet frame in a data structure;
determining an Ethernet destination address for the Ethernet frame;
determining an outgoing port based on the Ethernet destination address; and
forwarding the Ethernet frame to the outgoing port of said first optical network element.

14. The wayside communication system of claim 13 wherein the transmit method further comprising enqueueing the Ethernet frame according to predetermined rules of priority; and transmitting the Ethernet frame embodied in at least one optical network frame over the optical supervisory channel.

15. The wayside communication system of claim 1, wherein said second optical network element receives Ethernet frames utilizing a receive method, the receive method comprising:
receiving the at least one optical network frame having an Ethernet frame embodied therein;
recording an Ethernet source address associated with the Ethernet frame in a data structure;
determining an Ethernet destination address for the Ethernet frame;
determining an outgoing port based on the Ethernet destination address; and
forwarding the Ethernet frame to the outgoing port of the second optical network element.

16. The wayside communication system of claim 15 wherein the receive method further comprises enqueueing the Ethernet frame according to predetermined rules of priority, prior to the step of forwarding the Ethernet frame to the outgoing port of the second optical network element.

17. The wayside communication system of claim 2 wherein said third optical element forwards Ethernet frames utilizing a forwarding method, the forwarding method comprising:
receiving the at least optical network frame having an Ethernet frame embodied therein;
determining an Ethernet destination address for the Ethernet frame;
determining an outgoing port based on the Ethernet destination address; and
forwarding the Ethernet frame to the outgoing port of the second optical network element.

18. The wayside communication system of claim 17, wherein the forward method further comprises the steps of enqueueing the Ethernet frame according to predetermined rules of priority; and transmitting the Ethernet frame embodied in at least one optical network frame over the optical supervisory channel.

19. An optical network element for use in an optical network having a wayside Ethernet communication subsystem, the network element comprising:
an Ethernet interface operable to receive Ethernet frames;
a supervisory channel interface operable to transmit optical network frames over an optical supervisory channel of the optical network; and
a processor in data communication with the Ethernet interface and the supervisory channel interface, the processor adapted to map the Ethernet frame received from the Ethernet interface into one or more optical network frames and transmit the one or more optical network frames over the optical supervisory channel.

20. The optical network element of claim 19 wherein Ethernet frames are mapped into a payload portion of the one or more optical network frames.

21. The optical network element of claim 19 wherein the optical network element further defined as at least one of an optical amplifier and an optical add drop multiplexer.

22. The optical network element of claim 19 wherein said processor is further defined as a network processor.

23. The optical network element of claim 19 wherein said processor is a general purpose embedded microprocessor.

24. The optical network element of claim 19 wherein said processor is operable to label the at least one optical network frame, thereby distinguishing the at least one optical network frame from other types of traffic transmitted over the optical supervisory channel.

25. The optical network element of claim 24, wherein said processor is further operable to label the at least one optical network frame by at least one of prepending a custom tag to the at least one optical network frame, inserting a standard shimmed multi protocol layer switching header in the at least one optical network frame, overwriting an Ethernet protocol checksum field embodied in the at least one optical network frame, and defining custom point to point protocol types.

26. The optical network element of claim 25 wherein said processor is further operable to label the at least one optical network frame by encoding an identification of a custom point to point protocol.

27. A method for transmitting wayside data packets over an optical supervisory channel of an optical network, the method comprising:
receiving a data frame having a destination address at an optical network element connected to the optical network, wherein the data frame is formatted in accordance with an Ethernet protocol;
determining an output port of the optical network element based on the destination address associated with the data frame; and
forwarding the data frame to the output port for transmission over the optical supervisory channel of the optical network.

28. The method of claim 27 further comprising the step of mapping the data frame into a payload portion of at least one optical network frame.

29. The method of claim 27 further comprising the step of tagging the data frame with an identifier, wherein the identifier distinguishes the data frame from other types of traffic transmitted over the optical supervisory channel.

30. The method of claim 29 wherein the step of tagging further comprises at least one of prepending a custom tag to the at least one optical network frame, inserting a standard shimmed multi protocol layer switching header in the at least one optical network frame, overwriting an Ethernet protocol checksum field embodied in the at least one optical network frame, and defining custom point to point protocol types.

31. The method of claim 30 wherein the step of tagging further comprises encoding an identification of a custom point to point protocol.

32. A propagating wave for use in a wayside Ethernet system associated with an optical transmission system, the propagating wave comprising:
a plurality of optical network frames, wherein at least one Ethernet frame is mapped into one or more of the optical network frame and is propagated over an optical supervisory channel of the optical transmission system.

33. The propagating wave of claim 32 wherein the at least one Ethernet frame is mapped into a payload portion of the one or more optical network frames.
